(19) United States
(12) Patent Application Publication
(10) Pub. No.: US 2007/0180088 A1
(43) Pub. Date: Aug. 2, 2007

(54) Seamless roaming across multiple data networks

(75) Inventor: Lingyan Zhao, San Jose, CA (US)

Correspondence Address: BUCHANAN, INGERSOLL & ROONEY PC, POST OFFICE BOX 1404, ALEXANDRIA, VA, 22313-1404, US

(73) Assignee: Array Networks, Inc., Milpitas, CA (US)

(21) Appl. No.: 11/447,547

(22) Filed: Jun. 5, 2006

Related U.S. Application Data
(60) Provisional application No. 60/763,030, filed on Jan. 27, 2006.

(51) Int. Cl. G06F 15/173

(52) U.S. Cl. 709/223

(57) ABSTRACT

A method for seamless roaming on a client comprises the steps of installing a proxy on a client, wherein the proxy communicates with a content server via a network connection and intercepting data from at least one user application via the proxy on the client before the data is transmitted across the network connection.

### CROSS-REFERENCE TO RELATED APPLICATIONS

This application claims priority to U.S. Provisional Application No. 60/763,030, filed Jan. 27, 2006, which is incorporated herein in its entirety.

### FIELD OF THE INVENTION

This invention generally relates to a system or method for seamless roaming across multiple data networks, and more particularly a system and method for seamless roaming across multiple data networks having a proxy on a client or user's device, wherein the proxy communicates with a content server via a network connection, and intercepts or retrieves the data from at least one user application via the proxy on the client or user's device before the data of the at least one user application is transmitted across the network connection.

### BACKGROUND OF THE INVENTION

With all kinds of wireless data networks becoming more mature and more widely deployed, more and more users are mobilized now. WiFi, WiMAX, GPRS, CDMA1X, and 3G data together are covering almost every corner you can go to. Typically, when you are at your desk you can use your wired network; it is secure, fast and reliable. In addition, when moving around in an office building, WiFi, it is easy to use with satisfactory speed. When you are on the train you have GPRS or 3G etc., it is very convenient and is available wherever you need it. So the infrastructure is ready to allow people to keep connected while they are moving around.

However, wireless signals are not always stable. No matter what kind of wireless data networks users are using, they all suffer from signal interruptions. The interruptions might be caused by entering a tunnel while riding in a train or car, might be caused by interference from another source, or simply because the user is moving around. These signal interruptions will cause the user's data connection to be broken. If the user is downloading a large file then the user will have to connect back to re-download the whole file again. If the user is talking over a VoIP (Voice over Internet Protocol) phone, the user will have to redial the other party. The inconvenience is obvious.

In addition, users want to use the best available network. For example, if the user has been accessing data through cellular data network while the user is on the road, and the user comes into the office building, where WiFi access is available, the user will prefer to use the WiFi access. The user however, does not want to interrupt the ongoing data access, while still wanting to utilize the faster and more stable WiFi access.

Finally, security is also very important for users accessing wireless data networks. Not being able to access information or data when the user needs to affects the work efficiency. However, insecure access to information or data causes real damages. It is important to protect the user's data while the user is accessing it from any data network.

Wireless cards makers and service providers have proposed dual mode cards to attempt to solve these issues. Dual mode cards can connect to both cellular data networks and WiFi data networks. A dual mode card can detect which data network it can connect to and automatically establish the connection for the user. It can go one step further to automatically switch to cellular data networks when the WiFi signal becomes weak. However, seamless switching between different networks requires support on the service provider side. That means the user will have to use the same service provider for both his/her cellular data access and WiFi access. This is a big limitation. Furthermore, if the signal is completely lost for a certain period, even if it is a short period, it will be very hard for these dual mode cards to handle.

Accordingly, it would be desirable for a system and method, which provides a seamless roaming across multiple data networks wherein the system and method keeps the connections alive all the time, automatically switching to the best network and at the same time protecting their data and privacy. Furthermore, it would be desirable if the system and method provides the following characteristics:

Transparent—it should automatically detect the best available network and switch to it without user intervention. It should not require any prior knowledge of the network, nor should it require any support from any other devices on the networks, i.e., WiFi access points, gateways or routers.

Seamless—user's connection must not be interrupted when the user loses wireless signal for a short moment or when switching between networks. The user's data session should be able to continue once the wireless signal is restored or once the network switching is done.

Secure—user's data and privacy must be protected at all times.

In addition, it would be desirable if the approach does not rely on special hardware or the support from service providers and protects the user applications from interruptions or changes in the physical layer.

### SUMMARY OF THE INVENTION

In accordance with one embodiment, a method for seamless roaming on a client comprising: installing a proxy on a client, wherein the proxy communicates with a content server via a network connection; and intercepting data from at least one user application via the proxy on the client before the data is transmitted across the network connection.

In accordance with another embodiment, a system for seamless roaming comprising: a client, the client having a proxy, wherein the proxy communicates with a content server via a network connection and intercepts data from at least one user application via the proxy on the client before the data is transmitted across the network connection.

In accordance with a further embodiment, a computer implemented method for seamless roaming comprising the steps of: installing a proxy on a client, wherein the proxy communicates with a content server via a network connection; and intercepting data from at least one user application via the proxy on the client before the data is transmitted across the network connection.

In accordance with another embodiment, a computer readable media having thereon computer readable code for seamless roaming comprising the steps of: installing a proxy on a client, wherein the proxy communicates with a content server via a network connection; and intercepting data from at least one user application via the proxy on the client before the data is transmitted across the network connection.

### BRIEF DESCRIPTION OF THE DRAWINGS

The invention will now be described in greater detail with reference to the preferred embodiments illustrated in the accompanying drawings, in which like elements bear like reference numbers, and wherein:

FIG. 1 shows a schematic diagram of a multiple data network or plurality of access points connected to an Internet or Intranet.

FIG. 2 shows a diagram of a seamless roaming system according to one embodiment.

FIG. 3 shows a diagram of a seamless roaming system without a server agent.

FIG. 4 shows a diagram of a seamless roaming system with a server agent.

### DETAILED DESCRIPTION

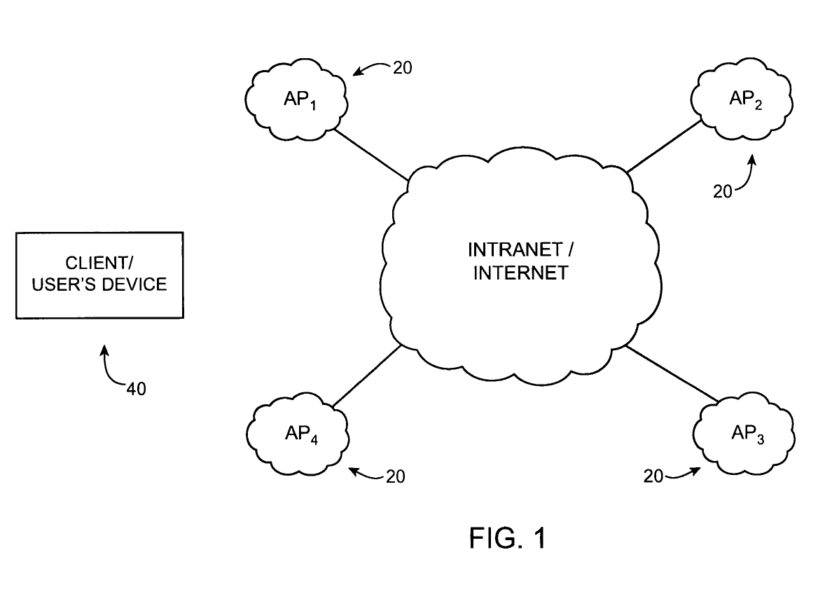

FIG. 1 shows a schematic diagram of a wireless network, consisting of a plurality of access points 20 spread over a large area. It can be appreciated that in one embodiment, each of the access points 20 can be connected to a wired network in the form of the Internet or Intranet 30. Typically, wireless networks provide hot spots where wireless clients or user's device 40 can connect to the Internet or Intranet 30 without regard for the particular networks to which they have attached for the moment. The concept can become very prevalent in large cities, where a combination of coffeehouses, libraries, and other public spaces offering wireless access allow clients to roam over a large area, staying more-or-less continuously connected. However as described above, users can experience signal interruptions or loss of network connections.

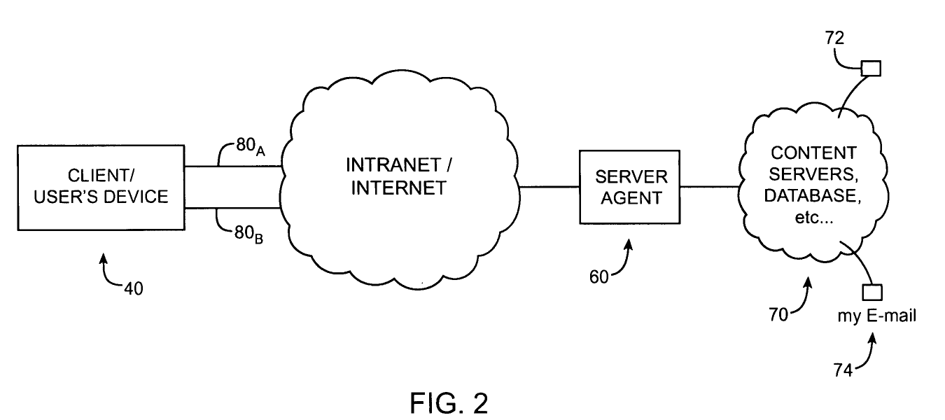

It can be appreciated that the client or user's devices 40 can be personal laptop computers, cellular telephones, Blackberry type devices, personal digital assistants (PDAs), desktop computers with wireless network connections or any other type of IP device having wireless network connectivity to a content server or database 70 (FIG. 2).

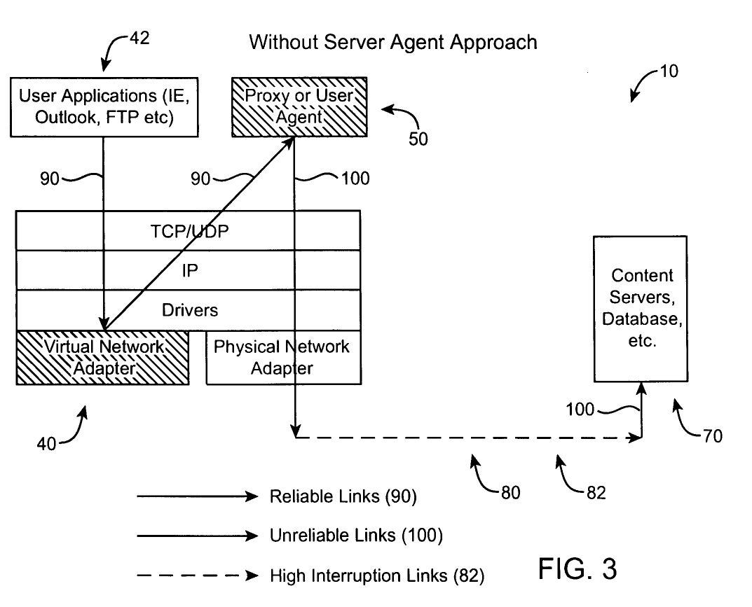

FIG. 2 shows a diagram of a seamless roaming system 10 according to one embodiment. As shown in FIG. 2, in one preferred embodiment, the seamless roaming system 10 comprises a proxy or user agent 50 (FIG. 3), which is installed on the client or user's device 40, and a server or server agent 60 installed in front of a content server or database 70. The content server or database 70 can include web servers or web browsers 72, hosting of e-mail accounts 74, and providing other information to clients through an information exchange facilitated by the Internet or Intranet 30. In addition, the server or server agent 60 communicates with the proxy or user agent 50, and provides the system 10 with the ability to provide secure seamless roaming across multiple data networks by utilizing proprietary protocols for encryption and decryption, flexibility and addition control of data buffering and transmission between the client or user's device 40 and the content server 70.

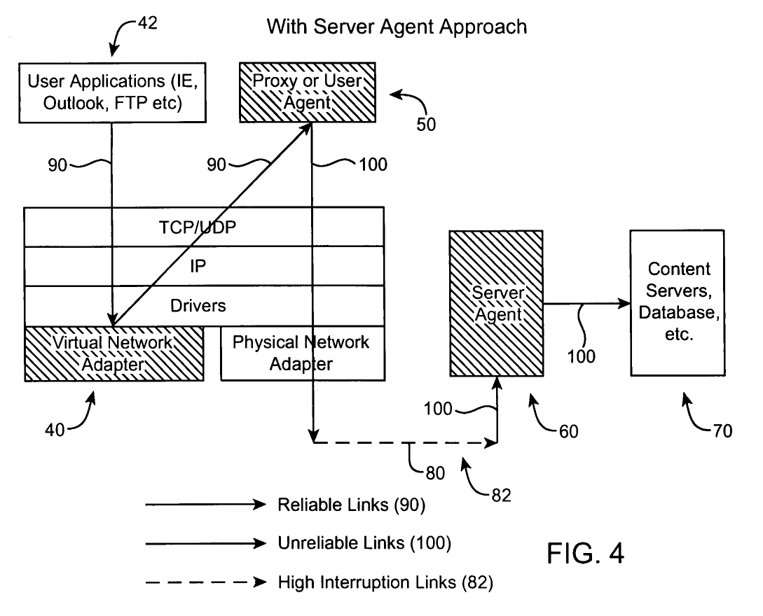

It can be appreciated that the server 60 in front of the content server or network 70 can be optional and for systems 10 where the wireless clients or user's device 40 connect to the Internet or Intranet 30 without regard for the particular networks to which they have attached for the moment, the systems 10 will typically not include the server or server agent 60. As shown in FIG. 2, the client or user's device 40 includes a wireless network connection 80, which can be WiFi, WiMAX, GPRS, CDMA1X, 3G data or any other suitable wireless network connection. In one embodiment, if the client or user's device 40 experiences an interruption in its network connection 80 with the content server 70, the client or user's device 40 buffers the data from the user's application (FIGS. 3 and 4) until a reconnection can be made with the content server 70. It can be appreciated that the reconnection can be made via the first network connection 80_{A} or a second network connection 80_{B}.

FIG. 3 shows a diagram of a seamless roaming system 10 without a server agent 60 in front of the content server 70. As shown in FIG. 3, the system 10 includes a client or user's device 40 having a set of communication protocols. The communication protocols include user applications 42 (such as Internet Explorer (IE), Outlook, File Transfer Protocol (FTP), etc.), a TCP/UDP layer (Transmission Control Protocol/User Datagram Protocol), an IP layer (Internet Protocol), drivers, a virtual network adapter, a physical network adapter, and a proxy or user agent 50. The proxy or user agent 50 is preferably installed on an existing client or user devices 40 via a software patch or other suitable manners. However, it can be appreciated that the client or user's device 40 can be originally configured or provided with a proxy or user agent 50. The proxy or user agent 50 intercepts or retrieves data from at least one of the user's application 42, and connects to the real servers or through a physical network adapter. The proxy or user agent 50 can also provide buffering capabilities during interruptions in the network signal or network connection 80 between the client or user's device 40 and the content server 70.

As shown in FIG. 3, the user applications 42, which need the seamless roaming (SR) capability, are preferably connect to the proxy or user agent 50, instead of the real servers through a physical network adapter. The client or user's device 40 also includes a memory allocation (not shown). As shown in FIG. 3, the proxy or user agent 50 intercepts or retrieves the data from the user applications 42 via a reliable link 90 from the virtual network adapter. The data from the user applications 42 are then transmitted via an unreliable link 100 through the physical network adapter and via a network connection 80 (and high interruption link 82) to the content server 70. As described herein, the network connection 80 is subject to wireless signal loss, interruption in service as a result of Intranet failure, or other failures, which can cause an interruption in the network connection 80 and the transmission of data from the content server 70 to the client or user's device 40.

It can be appreciated that the data from the user applications 42 can be retrieved or intercepted from any of the IP communication layers within the client or user's device 40 without departing from the present invention. For example, the data from the user application 42 can be retrieved from the TCP/UDP, IP, drivers, or virtual network adapter. The data is then transmitted though the physical network adapter to the content server 70. Upon a detection of a wireless signal loss or system failure, wherein the network connection 80 between the client or user's device 40 and the content server 70 occurs, the proxy or user agent 50 buffers the data from the at least one user application 42 or maintains the session or the active state of the at least one user application 42, which can support a seamless roaming capability until the client or user's device 40 can reconnect to the content server 70. The reconnection of the network connection 80 can be via the same wireless network connection 80_{A} (a first wireless network connection), a different wireless network connection 80_{B} (a second wireless network connection) or the same or different access points 20₁₋₄ using the same wireless network connection 80.

It can also be appreciated that in another aspect of the present invention, the proxy or user agent 50 will not buffer the data transmission of user applications for UDP packet transmissions, including VoIP data. For example, with VoIP data transmission, it is not necessary to buffer the data from the client or user's device based on the type of data transmission.

FIG. 4 shows a diagram of a seamless roaming system 10 with a server or server agent 60. In one preferred embodiment, as shown in FIG. 4, the server or server agent 60 (i.e., software application) is installed in front of the content server or network 20, in which the user's device 40 accesses. As shown in FIG. 4, the system 20 is comprised of a proxy or user agent 50, which intercepts or retrieves the data from the user applications 42 via a reliable link 90 from the virtual network adapter. The data from the user applications 42 is then transmitted via an unreliable link 100 through the physical network adapter and via a network connection 80 (and high interruption link 82) to the server or server agent 60, which is in front of the content server or database 70.

In one preferred embodiment, the proxy or user agent 50 and the server or server agent 60 communicate with each other through proprietary protocols. In use, the proxy or user agent 50 and the server or server agent 60 work together to hide the physical connection from the user applications 42 and the content server or database 70. When an interruption or change in the network connection 80 is detect, the proxy or user agent 50 can be configured to automatically switch to a new network connection 80, i.e., from a first network connection 80_{A} to a second network connection 80_{B} or to the fastest network connection 80 if more than one network connection 80 is available. In addition, data from the user's device 40 is buffered or state of the user application is maintained during the network switching. Thus, if the signal is lost or interrupted for a short period, for example driving through a tunnel or entering a building, the active session is not lost when a new network connection 80 is detected.

To make this transparent, the proxy or user agent 50 automatically configures the user's device 40 so that user applications 42 are connected to the proxy or user agent 50 without the user's applications 42 being able to recognize or knowing that the data is being rerouted through the proxy or user agent 50. It can be appreciated that this can be done in a number of ways and at different layers including:

Explicit Proxy—Proxy or user agent 40 can automatically configure explicit proxy for the applications it wants to protect. For example, on Windows, the proxy or user agent 40 can configure Internet Explorer (IE) to connect to the proxy or user agent 40 by specifying a local proxy. This approach is good for specific applications.

Socket Layer—some network stacks allow a layer being inserted into the socket layer and all socket Application Programming Interface (API) calls will be passed through the new layer. This gives you an opportunity to examine or process the packets or redirect a connection before it leaves the user's device. Microsoft Layered Service Provider (LSP), also known as Service Provider Interface (SPI), is an example of such usage. This approach is good for applications use socket API.

Transport Layer—some network stacks provide interfaces to hook a layer on top of transport layer (TCP or UDP) to intercept all TCP or UDP traffic, for example Windows Transport Device Interface (TDI). This approach is good for all applications using TCP or UDP, but cannot handle traffic directly generated from IP layer.

Device Driver—at this layer, usually it will be a virtual network adaptor, a virtual PPP (Point-to-Point Protocol) adaptor or a virtual serial port. These virtual devices are capable of intercepting all IP packets without having to know anything about the user applications.

It can also be appreciated that the approach to intercept the traffic might not be limited to these mentioned above. For example, the proxy or user agent 50 can terminate the user application connection, but it is not required. Accordingly, as long as the user applications 42 are not directly sending data through the physical network link they will not be affected when physical network link is interrupted.

In another embodiment, when the proxy or user agent 50 retrieves data it should encrypted before it is sent to the server or server agent 60. The server or server agent 60 then decrypts the encrypted data and forwards the data to the real content servers. When there are interruptions, the proxy or user agent 50 should transparently reconnect to the server or server agent 60 through the best available network 20. In addition, the proxy or user agent 50 and server or server agent 60 should buffer data when necessary during the reconnection and exchange information regarding the previous session so that the client or user's device 40 can continue to transmit where the data transmission was ceased or terminated, and also having the ability to retransmit data when necessary. This guarantees that the switch is seamless.

It can be appreciated that comparing the proxy or user agent 50 and server or server agent 60 method and system with the dual mode card solution, the proxy or user agent 50 and the server or server agent 60 has the following advantages:

Independent of hardware, most of the time there is absolutely no new hardware purchase necessary.

Easy to deploy, no infrastructure changes.

Independent of Internet Service Providers

Work with any IP network—cellular data, WiFi, WiMAX, Wired LAN and even

Can tolerate short period wireless signal loss or network interruptions

With added security by encrypting user's traffic before it leaves the user's computer.

It can be appreciated that many systems including virtual private networking equipment and can be modified to support a seamless roaming protocol. For example, some systems already have the infrastructure to implement seamless roaming.

For example, a Virtual Private Network (VPN) system or content server or database 70 such as Array Networks® VPN appliances can be modified to receive proxy or user agent 50 and the server or server agent 60 software patches or modification that allow client and user devices 40 to be able to reconnect automatically to the content server or database 70. It can be appreciated that a virtual private network system is not limiting and that the system and methods as described herein can be applied or implemented on any content server, database or other suitable networking device or server.

In addition, by providing a computer implemented software application incorporating a method and system of seamless secure roaming, any VPN client system, client or user's device 40 can be modified to distinguish the difference between a reconnection and new connection. In one preferred embodiment, the client or user's device 40 can be developed that can keep the client session active while waiting for the client or user's device 40 to reconnect until it times out. Accordingly, it is important that the client or user's device 40 be able to automatically detect available networks and switch to the most desirable network connection 80.

In addition, the client or user's device 40 should be capable of buffering data in case of network interruptions, so that the switching or reconnecting is truly seamless. It can be appreciated that data buffering can impact the performance of the client or user's device 40 because of the memory allocation needed to perform the data buffering. According to one aspect, a size limit can be placed on the client or user's device 40 to limit the amount of data buffering. The size limit is preferably an amount that does not utilize more than a specified percent of the client or user's device 40 memory allocation (not shown). It can be appreciated that when the proxy or user agent 50 side has connections with very long latencies, a size limit for how much the proxy or user agent 50 can buffer for all users can be important. It can be appreciated that in a preferred embodiment, the limit should prevent the client or user's device 40 from exhausting all memory.

In another embodiment, it can be appreciated that without buffering, the user's data recovery can depend on TCP retransmission and in some cases, UDP applications might lose data in this case.

It can also be appreciated that in another embodiment, the seamless roaming system 10 can be configured to automatically reconnect the client or user's device 40 to a VPN system, content server or database 70, if the connection is interrupted for any reason. In one embodiment, the user's device 40 is preferably configured to retry or attempt to reconnect with the VPN system, content server or database 70 several times or until it times out. During retry or attempts to reconnect with the VPN system, content server or database 70, the client or user's device 40 buffers the applications data, and once the user's device is reconnected to the VPN system, content server or database 70, the proxy or user agent 50 preferably transmits the buffered data to the VPN system, content server or database 70.

In addition, it can be appreciated that with the system 10, the system 10 can provide a trade off of the time out value. For example, if the time out value is too short, the wireless signal might not be restored. Alternatively, if the time out value is too long the client will have to buffer a lot of data, the buffering data can consume the user's device's memory. Preferably, the reconnect time for the proxy or user agent 50 will be set to 30 seconds to three minutes and more preferably about 45 seconds to two minutes and most preferably about one minute.

In addition, the client or user's device can be configured to automatically detect all available network connections 80 and switch to the fastest one if possible. In addition, the client or user can enable or disable this feature on the client or user's device 40. In addition, the client or user's device 40 can also be allowed to selectively disable switching to certain network adapters. For example, existing connections with any VPN system, content server, or database 70 do not need to be dropped before the new connection is established to minimize the packet retransmission overhead. In addition, if the switching fails, the client or user's device 40 can keep using the existing connection and user's session will not be interrupted. Once the new connection is established with the VPN system, content server or database 70, the data can be sent on the new network connection 80B and the old network connection 80 can be terminated.

In another embodiment, in case the VPN system, content server or database 70 loses the network connection 80 to a client the server agent can be used to keep the user's session and wait for the client or user's device to reconnect back until it times out. During this period, the client or user's device 40 buffers the data from the backend servers. Once the client or user's device 40 reconnects or connects back with the VPN system, content server or database 70, the client or user's device 40 preferably transmits the buffered data.

When the VPN system, content server or database 70 receives a new network connection 80 request from a connected client or user's device 40, the VPN system, content server or database 70 preferably treats the request as a client or user's device 40 switching networks. Accordingly, the client or user's device can start sending data on the new connection immediately after a session information exchange and the old client connection can be terminated.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A method for seamless roaming on a client comprising:
installing a proxy on a client, wherein the proxy communicates with a content server via a network connection; and
intercepting data from at least one user application via the proxy on the client before the data is transmitted across the network connection.

2. The method of claim 1, further comprising buffering data within the client or maintaining the session or active state of the user application upon an interruption in the network connection.

3. The method of claim 1, further comprising installing a server in front of the content server, wherein the server forwards data to the content server.

4. The method of claim 1, further comprising switching from a first access point to a second access point upon an interruption in the network connection with the content server.

5. The method of claim 1, wherein intercepting data from the at least one user application further comprises intercepting only the data from the at least one user application which requires seamless roaming capabilities.

6. The method of claim 1, further comprising automatically switching from a first network connection to a second network connection upon a detection of an interruption in the first network connection.

7. The method of claim 6, wherein the step of automatically switching from a first network connection to a second network connection further comprises switching to the second network connection having the fastest network connection if more than one second network connections are available.

8. The method of claim 1, wherein the proxy further includes a network stack, and inserting a new layer into a socket layer and passing all socket API calls through the new layer.

9. The method of claim 1, wherein the proxy further includes a network stack and adding or hooking a layer on top of a transport layer (TCP or UDP) to intercept all TCP or UDP traffic.

10. The method of claim 1, wherein the proxy further includes a virtual device selected from a group comprising a network adapter, a virtual Point-to-Point (PPP) adapter or a virtual serial port, and wherein the virtual device intercepts all IP packets without the at least one user applications knowledge.

11. The method of claim 1, further comprising intercepting data from the user's application and not directly sending the data through a physical network link during interruption of the network link.

12. A system for seamless roaming comprising:
a client, the client having a proxy, wherein the proxy communicates with a content server via a network connection and intercepts data from at least one user application via the proxy on the client before the data is transmitted across the network connection.

13. The system of claim 12, wherein the client buffers data within the client upon an interruption in the network connection.

14. The system of claim 12, further comprising a server and a content server, wherein the server is installed in front of the content server and forwards data to the content server.

15. The system of claim 12, further comprising switching from a first access point to a second access point upon an interruption in the network connection with the content server.

16. The system of claim 12, wherein intercepting data from the at least one user application further comprises intercepting only the data from the at least one user application which requires seamless roaming capabilities.

17. The system of claim 12, further comprising automatically switching from a first network connection to a second network connection upon a detection of an interruption in the first network connection.

18. The system of claim 17, wherein the step of automatically switching from a first network connection to a second network connection further comprises switching to the second network connection having the fastest network connection if more than one second network connections are available.

19. The system of claim 12, wherein the proxy further includes a network stack, and inserting a new layer into a socket layer and passing all socket API calls through the new layer.

20. The system of claim 12, wherein the proxy further includes a network stack and adding or hooking a layer on top of a transport layer (TCP or UDP) to intercept all TCP or UDP traffic.

21. The system of claim 12, wherein the proxy further includes a virtual device selected from a group comprising a network adapter, a virtual Point-to-Point (PPP) adapter or a virtual serial port, and wherein the virtual device intercepts all IP packets without the at least one user applications knowledge.

22. The system of claim 12, further comprising intercepting data from the user's application and not directly sending the data through a physical network link during interruption of the network link.

23. The system of claim 12, wherein the at least one user application is protected from interruptions or changes in a physical layer by hiding the physical connection from the at least one user application and the content server.
